(19) United States
(12) Patent Application Publication
(10) Pub. No.: US 2025/0168762 A1
(43) Pub. Date: May 22, 2025

(54) METHODS AND DEVICES FOR CONNECTION MANAGEMENT OF A WIRELESS NETWORK STATION

(71) Applicant: SAGEMCOM BROADBAND SAS, BOIS-COLOMBES (FR)

(72) Inventor: Sylvain LE ROUX, BOIS-COLOMBES (FR)

(21) Appl. No.: 18/954,175

(22) Filed: Nov. 20, 2024

(30) Foreign Application Priority Data
Nov. 20, 2023 (FR) 2312730

(51) Int. Cl. H04W 48/20; H04W 48/10

(52) U.S. Cl. CPC H04W 48/20; H04W 48/10

(57) ABSTRACT

A method implemented by a first communication device is described, comprising receiving an identifier of a station connected to a first access point of a first set of access points broadcasting a first wireless network, determining a host access point of a second set of access points broadcasting a second network for connecting the station; transmitting to the second wireless network of the host access point a request to configure a third wireless network by the host access point, said configuration using the connection elements of the first wireless network; and moving the station to the given access point to enable the station to connect to the third network using the connection elements of the first wireless network. Also described is a method implemented by a second device, comprising a controller of the first network, as well as implementation devices.

### CROSS-REFERENCE TO RELATED APPLICATIONS

The present application claims priority to French Application No. 2312730 filed with the Intellectual Property Office of France on Nov. 20, 2023 and entitled “METHODS AND DEVICES FOR CONNECTION MANAGEMENT OF A WIRELESS NETWORK STATION,” which is incorporated herein by reference in their entirety for all purposes.

### TECHNICAL FIELD

Disclosed herein are methods and devices for managing the connection of a wireless communication network station, in particular for managing the transition of the station between two access points. The field of application is that of wireless networks.

### TECHNICAL BACKGROUND

In a wireless Internet network, such as a home network, some areas may not be adequately covered by the network equipment installed by a customer. However, these same areas may be served by one or more access points from other networks, such as a neighbor's network. Access to a network other than the customer's is usually password-protected, and requires device-by-device configuration to enable access, which is often carried out manually. This does not allow for a simple switchover from the customer's network to another network.

The invention proposes to fill these gaps.

### SUMMARY

One or more embodiments relate to a method implemented by a first communication device, comprising:
receiving an identifier from a station connected to a first access point of a first set of access points broadcasting a first wireless network, the first wireless network being configured with first connection elements, the connection elements comprising information necessary and sufficient for a station to connect to a wireless network;
determining at least one second set of access points broadcasting a second wireless network, each second set of access points comprising at least one second access point within range of the station so that the station can connect thereto, each second wireless network being configured with respective second connection elements, distinct from the first connection elements;
determining, from the at least one second access point, a given access point for connecting the station;
initiating the transmission, to the given access point, of a request to configure a third wireless network by the given access point, said configuration using the connection elements of the first wireless network;
transmitting to the first wireless network a message comprising an identifier of the given access point to initiate a move of the station to the given access point, to enable the station to connect to the third network using the connection elements of the first wireless network.

Note that the first set of access points may comprise one or more access points.

Thus, it is proposed that the second network uses characteristics specific to the first network for a transition of the station to an access point of the second network, this transition being transparent to the user. The coverage area of the first network is thus extended by the second network. The second network may, for example, be a mesh network.

In one embodiment, the identifier of the given access point is the BSSID of the access point (for example a virtual access point) broadcasting said third network to the host access point. In another embodiment, this identifier is the SSID of said third network.

The invention is particularly advantageous in the context of an area with a high density of wireless networks.

In one or more embodiments, the method comprises
receiving the first connection elements from the first wireless network; and
initiating the transmission of the first connection elements to the given access point.

In one or more embodiments, the first connection elements comprise an SSID of the first wireless network, a password, and an encryption mode.

In one or more embodiments, the determination of at least a second set of access points broadcasting a second wireless network and of the given access point comprising:
obtaining one or more respective identifiers of one or more second wireless networks from the first wireless network;
transmitting, to each of the one or more second networks identified by the respective identifier(s), a request to obtain at least one quality criterion of at least one access point of each of the one or more second identified networks, the quality criterion being a function of a signal measurement between the at least one access point and the station;
receiving at least one quality criterion for at least one access point;
selecting the given access point on the basis of at least one quality criterion.

In one or more embodiments, the quality criterion is additionally a function of at least one of:
a number of stations connected to an access point of a second identified network; and
an available transmission time of an access point of a second identified network.

In one or more embodiments, determining a given second access point comprises:
determining at least one second network on the basis of a criterion of geographical proximity of the at least one second network to the first network.

In one or more embodiments, the at least one second wireless network is a mesh network.

One or more embodiments further relate to a first communication device comprising a processor configured to implement the method according to any of the above exemplary embodiments.

One or more embodiments further relate to a method implemented by a second communication device of a first wireless communication network broadcast by a first set of access points, the method comprising:
transmitting, to a first communication device, an identifier of a station connected to an access point of the first communication network,
transmitting first connection elements for configuring an access point of a second communication network within range of the station, the second wireless network being broadcast by a second set of access points and being configured with second connection elements distinct from the first connection elements, the connection elements comprising information necessary and sufficient for a station to connect to a wireless network configured with these elements;
receiving, from the first communication device, an identifier of a given access point of the second set of access points having configured a third wireless communication network with the first connection elements;
initiating a move of the station to the given access point to enable the station to connect to the third network using the connection elements of the first wireless network.

In one or more embodiments, the method comprises checking whether a connection quality criterion of a station connected to an access point of the first wireless network is below a threshold, a station identifier being transmitted if so.

In one or more embodiments, the method comprises
transmitting to at least one access point of the first set of access points a request to determine one or more second networks within range of the at least one access point;
receiving, from the at least one access point, one or more respective identifiers of the second networks determined to be within range;
transmitting the identifier(s) of the second network(s) within range to the first device.

One or more embodiments further relate to a second communication device comprising a processor configured to implement the method according to any of the above exemplary embodiments.

In one or more embodiments, the second device comprises a mesh network controller.

In one or more embodiments, a set of access points comprises one or more access points.

### BRIEF DESCRIPTION OF THE FIGURES

Further features and advantages will become apparent from the following detailed description, which may be understood with reference to the attached drawings in which:

FIG. 1 is a schematic diagram of a set of adjacent wireless networks showing the context of the invention;

FIG. 2 is a flowchart of a method according to an exemplary embodiment;

FIG. 3 is a detailed message sequencing diagram of an example of the method shown in FIG. 2;

FIG. 4 is a block diagram of a device for implementing one or more exemplary embodiments.

FIG. 5 is a schematic block diagram showing the implementation of ESS and SSIDs.

### DETAILED DESCRIPTION

In the following description, identical, similar or analogous elements will be referred to by the same reference numbers. The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in a memory or a readable medium accessible directly or via another module by the processor or controller.

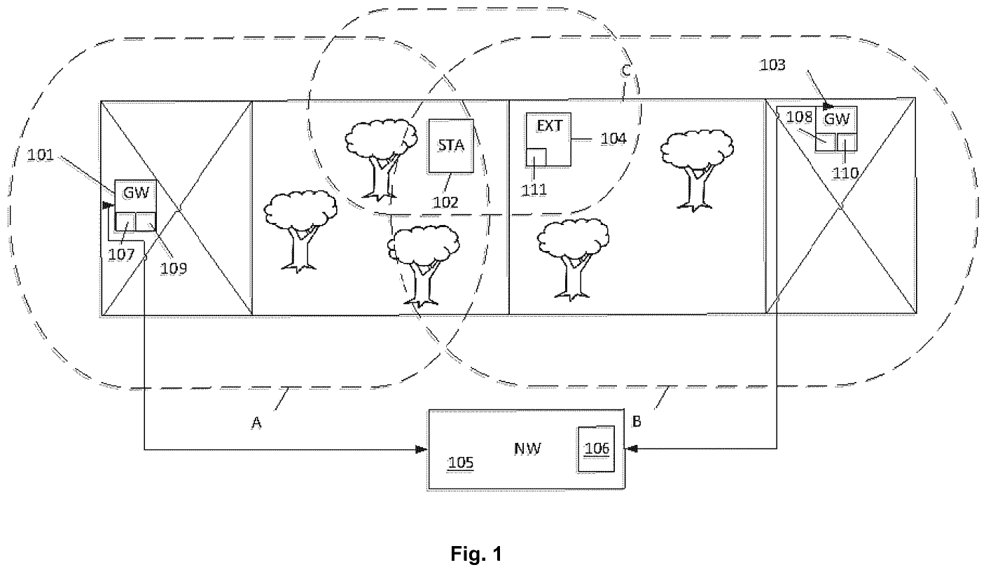

FIG. 1 is a schematic diagram of a set of adjacent wireless networks showing the context of one or more exemplary embodiments, in a non-limiting fashion. In the example shown in FIG. 1, two wireless networks are shown, networks A and B, whose respective ranges are shown by dashed lines. Network A comprises a gateway (‘GW’) comprising an access point (‘AP’) functionality 101, while network B comprises a gateway comprising an access point functionality 103. Gateways 101 and 103 are connected to a network operator's network 105, for example via a fiber optic connection. In the simplified example shown in FIG. 1, a station (‘STA’) 102 is associated with the gateway 101, and a wireless network extender (‘EXT’) 104 is associated with the gateway 103. A device 106 is part of or connected to the operator's network (‘NW’) 105. The device 106, which is for example a server, is under the control of the network operator or a third party (referred to as the ‘service provider’) and provides the functionalities described below. These functionalities can also be provided by a plurality of devices, depending on the embodiment. The service provider is the entity that offers the service described in the various embodiments.

Each network comprises a controller, which is an entity responsible for controlling the network and communicating with the operator's network and service provider's devices. In FIG. 1, the respective controllers for the networks A and B are designated by references 107 and 108 and are hosted by the gateways 101 and 103. A controller can be installed in a device other than the gateway. Any device with an access point function also has an entity responsible for operating this access point. In FIG. 1, these entities are referred to as 109, 110 and 111 respectively for the gateways 101, 103 and the extender 104. By entity, we mean a software component, a hardware component, or a combination of the two.

Although the two gateways 101 and 103 are connected to the same operator network in the example shown in FIG. 1, connections to separate networks are not outside the invention. The wireless networks A and B are, for example, local or home wireless networks.

In the embodiments described, both the networks A and B are multi-access point wireless networks, comprising one or more access points controlled by a central controller. An example of a mesh-based multi-access point network is described in the ‘Wi-Fi EasyMesh’ standard (registered trademark) maintained by the ‘WiFi Alliance’ organization (registered trademark). However, the principles described are applicable to other types of wireless networks, including non-mesh networks.

The ‘Wi-Fi EasyMesh’ standard defines a wireless network with potentially multiple access points, comprising a multi-access point controller. A multi-access point controller has the function of accessing and controlling other access points in its network, these other access points comprising a functionality, referred to as an ‘agent’, which is an access point functionality in its own right.

Returning to the example of FIG. 1 and placing it in the context of an ‘EasyMesh’ network, the controllers 107 and 108 are multi-access point controllers, and the entities 109 to 111 managing the access points are access point agents.

In one or more embodiments, an access point of a first wireless network, known as a host access point, configures a network with the connection elements of a second wireless network, to which a station is connected. The connection elements are the necessary and sufficient information to connect a station to the second wireless network.

The first and second networks are, for example, wireless networks according to the IEEE 802.11 family of standards, distributed by two sets of access points respectively. Note that a set may comprise one or more access points. Each of the two networks corresponds to a separate Extended Service Set (ESS). An ESS is made up of one or more Basic Service Sets (BSS). An ESS has an identifier, called SSID (Service Set IDentifier), which is used by every BSS in that ESS. However, each BSS has its own identifier, called a BSSID. The additional network created by the host access point with the connection elements of the second network is, for example, a network corresponding to a third ESS, but using the SSID of the first network.

FIG. 5 is a schematic block diagram showing the implementation of ESS and SSIDs. The diagram shows two gateways, P1 and P2. The gateway P1 is connected to two access points, AP1.1 and AP1.2 respectively. The gateway P2 is also connected to two access points, AP2.1 and AP2.2. The access point AP1.1 creates two BSSs, BSS 1.1.1 and 1.1.2. The access point AP1.2 creates three BSSs, 1.2.1, 1.2.2 and 1.2.3 respectively. The access point AP2.1 creates a BSS 2.1.1, while the AP2.2 access point creates a BSS 2.2.1. A first ESS comprises BSSs 1.1.1, 1.2.1 and 1.2.2. This first ESS has SSID ‘A’. A second ESS comprises BSSs 1.1.2 and 1.2.3. This second ESS has SSID ‘B’. A third ESS comprises BSSs 2.1.1 and 2.2.1. This third ESS also has SSID ‘B’. There are therefore two ESSs with the same SSID, although the access points creating the respective BSSs of the second and third ESSs are connected to different gateways.

In the example shown in FIG. 1, the first network is network B and the second network is network A.

This makes it easy for the station to connect to the network newly created by the host access point, since the station already has all the information it needs to connect to that network, in the form of connection elements. No manual configuration is required, whether by a station user or by an administrator of the second wireless network.

The second wireless network is adjacent to the first wireless network in the sense that the station, while connected to an access point of the first network, is within range of at least one access point of the second network to be able to connect to it following a request to transition that access point of the second network.

The host access point is adapted to enable it both to broadcast a wireless network based on connection information from the second network, while continuing to broadcast the first wireless network and remaining connected to its own wireless network. The host access point can, for example, configure a plurality of virtual access points on a single radio. It can also be equipped with a plurality of radios to work on different frequency bands.

The first and second ESS are distinguished by separate connection elements and are linked to one or more operator networks by distinct gateways. When the station connects to an ESS that is broadcast by the second network, its connectivity beyond the second wireless network therefore passes through a gateway other than that of the first network.

In an IEEE 802.11 network, for example, the connection elements comprise a network identifier such as the SSID, a password, and the encryption mode. In other contexts, this information may differ.

In the example shown in FIG. 1, for example, station 102 is located at the edge of the coverage area of its network A, in quality-of-service conditions below an acceptable threshold. However, this station is located within the coverage area of network B, which may potentially provide it with a quality of service above the expected threshold. In such a case, the extender 104 can set up a wireless network C using the connection elements of the network A. The gateway 103 can also create this network if it is within range of the station 102. That station can then connect to the new network C.

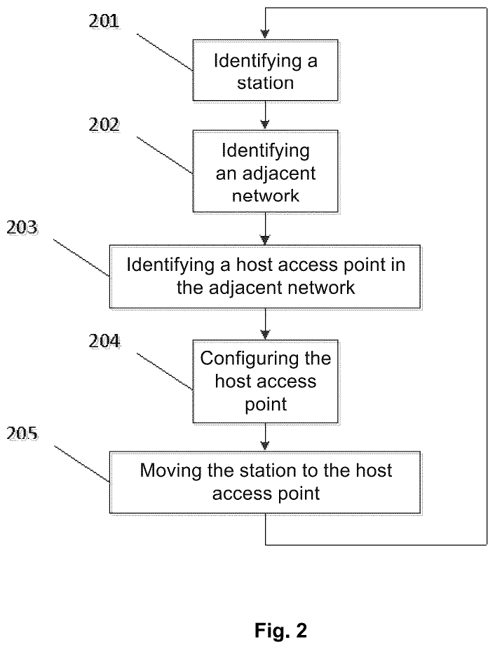

FIG. 2 is a flowchart of a method according to one or more embodiments; The method comprises:
201—Identifying a station likely to migrate to a host access point outside the station's initial network.
202—Identifying one or more adjacent wireless networks.
203—Identifying, in the adjacent network(s), an access point likely to host the station, called the host access point.
204—Transferring the connection elements of the wireless network with which the station is associated and configuring a wireless network, by the host access point, using the connection elements.
205—Moving the station to the host access point.

A first step 201 comprises identifying at least one station likely to benefit from a move to another network. Such a station is referred to as ‘eligible’ in the following.

By way of example, and as already briefly mentioned, an eligible station may be a station likely to obtain a better quality of service by moving to a host access point of another network.

In one embodiment of this step, the signal level emitted by a station is checked for all the access points in the station's current network. If this level is below a threshold for all access points, then the station is eligible.

In the example of a network such as the one showed in FIG. 1, the first step is mainly managed by a controller of the wireless network to which the eligible station is connected. The controller obtains the measurements mentioned for the stations in the wireless network and decides on this basis whether a station is eligible or not. Corresponding information is transmitted via the operator network to the service provider's device.

The following steps are carried out individually for each station. However, it should be noted that it is quite possible for certain steps to be implemented for one eligible station and not have to be repeated for another eligible station. For example, a plurality of stations on the same network could be transferred to the same host access point. That host access point only needs to set up a wireless network once, using the original network connection elements of the eligible stations.

A second step 202 comprises identifying at least one compatible adjacent wireless network for an eligible station.

An adjacent wireless network is one that is geographically close to the initial network of the eligible station. A compatible adjacent wireless network is a wireless network configured to allow the provision of a host access point.

In a first embodiment of this step, a list comprising one or more compatible adjacent networks is generated using a database comprising the geographical coordinates of wireless networks, for example all the wireless networks connected to the operator's network. The database is used to determine the geographical coordinates of the eligible station's initial wireless network and of nearby networks.

For example, the selection of compatible wireless networks can be based on a distance threshold from the initial network of the eligible station. This threshold characterizes, for example, the maximum expected range of a home wireless network, but can be chosen differently.

The database comprises, for example, information on other compatible wireless networks of the network operator to which the eligible station's initial wireless network is connected. In one embodiment, this database also comprises information about compatible wireless networks managed by one or more other operators.

According to a second embodiment of this step, the device implementing the second step knows a unique identifier of each compatible wireless network in its database. This unique identifier can be the BSSID (for ‘Basic Service Set Identifier’). The eligible station's initial network access point(s) scan the radio environment to determine the identifiers of adjacent networks. These identifiers can, for example, be obtained by listening to Beacon Frame messages transmitted regularly by the access points of each wireless network. The list of BSSIDs thus found is transmitted to the device implementing the present step. The device determines compatible adjacent wireless networks by determining compatible wireless networks in its database whose BSSIDs are also found in the received list. In this embodiment, the geographical location of the various networks is not necessary, as the notion of an adjacent network is based on the ability to receive a signal from that network.

In the example of a network such as that shown in FIG. 1, the first embodiment of the second step is, for example, implemented primarily by a device of the service provider. It is assumed that this device has access to a database with geographical locations. The second embodiment can be implemented primarily by a controller of the eligible station's wireless network in order to obtain the list of adjacent network identifiers from the various access points of its network, and by a device of the aforementioned service provider, in order to compare this list with the list of compatible wireless networks.

A third step 203 comprises, for an eligible station, identifying a host access point in one of the compatible adjacent networks determined in the previous step for this eligible station.

This step comprises triggering a quality indicator measurement phase in each of the previously identified compatible adjacent networks, to determine whether the network is likely able to host said eligible station.

In one embodiment, the quality indicator is the signal level emitted by the eligible station (for example the RSSI), as seen from an access point of a compatible adjacent network. This measurement can be carried out for one, several, or all access points of a compatible adjacent network.

According to one embodiment of this step, in the context of an ‘EasyMesh’ multi-point network, this measurement may be taken by the “Unassociated STA monitoring” function, among other ways.

In one embodiment, one or more additional parameters or metrics other than signal level are used to determine the extent to which an access point in a compatible adjacent network is able to accommodate an eligible station. These parameters may comprise one or more of the following: the number of stations already connected to an access point, the available airtime, etc. A score based on the parameters taken into consideration can then be associated with the pair (eligible station, access point from a compatible adjacent network). The score may, for example, be the result of a linear combination of the selected parameters. Equation 1 shows this for the case of the three parameters mentioned above:

$$Score ( AP , STA ) = a * NiveauDeSignal ( AP , STA ) + b * TxOP ( AP ) - c * NbSTA ( AP ) \qquad [ Equation 1 ]$$

where a, b and c are weighting coefficients, NiveauDeSignal is the signal level of the eligible station STA as seen from the access point AP, TxOP is the available transmission time in percent and NbSTA is the number of stations associated with the access point.

For each compatible adjacent network, and depending on the chosen implementation, this phase may result in the identification of one or more access points (best access point, identification of a plurality of access points associated with respective scores, etc.), or, if applicable, no access point likely able to serve as a host access point. Based on feedback from the various compatible adjacent networks, a host access point is selected for the eligible station.

In the context of a network such as that showed in FIG. 1, measurements from the access points of a compatible adjacent wireless network can, for example, be obtained and processed by the controller of that wireless network, and the result can be communicated to the aforementioned device of the service provider.

A fourth step 204 involves transmitting wireless network connection elements from the eligible station to the host access point determined in the previous step, and configuring a wireless network using these elements.

According to a first embodiment of this step, transmission is carried out via a device controlled by the service provider, for example the device 106.

In a second embodiment of this step, transmission takes place directly between the wireless network of the eligible station and the wireless network of the chosen host access point.

The host access point then configures a wireless network with the connection elements received.

In a network such as the one showed in FIG. 1, transmission can take place from the wireless network controller of the eligible station to the network controller of the host access point. The host access point's network controller then transmits the information to the host access point. In the specific context of an ‘EasyMesh’ network, this last step can be carried out using the AP AutoConfiguration mechanism.

A fifth step 205 comprises moving an eligible station to the host access point.

Moving an eligible station to the host access point comprises transmitting a request to this effect to the eligible station's wireless network controller, such a request comprising an identifier of the host access point. This identifier is, for example, the BSSID of the host access point.

In one embodiment, this request is sent by the service provider's device.

The controller receiving the request then initiates the movement of the eligible station to the host access point in a manner known per se.

For example, in a multi-access point wireless network, the controller transmits a request to the entity or agent in charge of the access point to which the eligible station is connected, and this entity or agent relays the request to the eligible station.

In an ‘EasyMesh’ network, this request can take the form of a ‘Client Steering Request’ message. The access point to which the eligible station is connected then transmits a transition request to the eligible station, which in the case of an ‘EasyMesh’ network can be a ‘BSS Transition Request’ message compliant with the IEEE 802.11V standard, the message comprising the BSSID of the host access point.

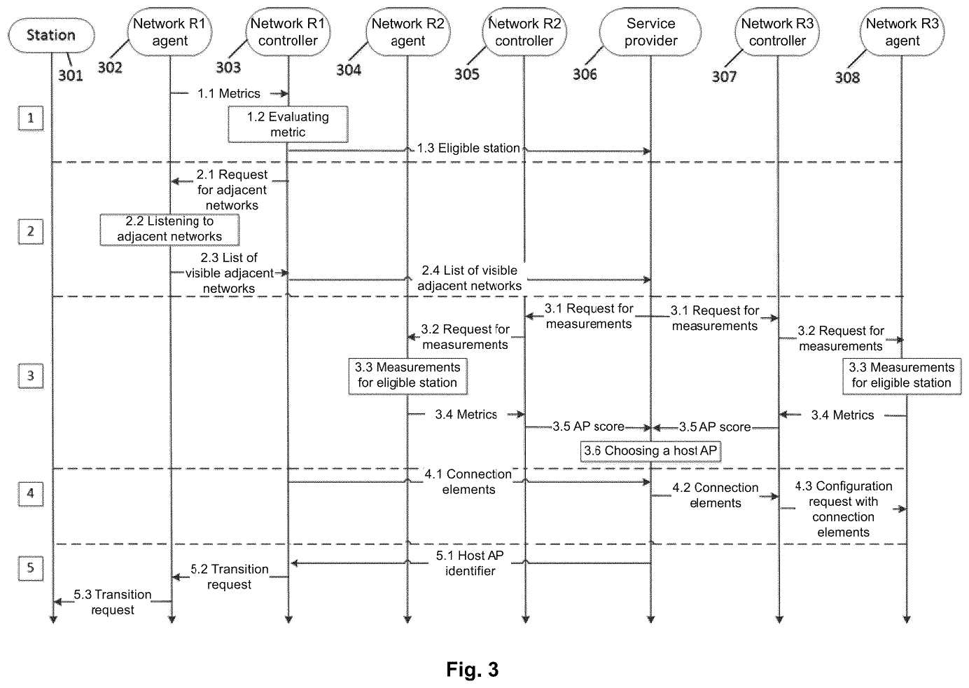

FIG. 3 is a message sequence diagram showing the method shown in FIG. 2 in an example of a multi-access point network environment. In FIG. 3, the various steps mentioned above are shown on the left-hand side of the diagram, with sub-steps indicated as messages between entities or actions by entities with a reference X.Y, where X denotes the step and Y the sub-step.

A station 301 is initially connected to a wireless network R1 via an access point managed by an agent 302. The network R1 further comprises a controller 303. Two other wireless networks, R2 and R3, are nearby. In this example, the two networks R2 and R3 are adjacent and compatible networks. A service provider's device 306 is connected to the operator's network to which networks R1 to R3 are connected.

In 1.1, the controller 303 of the network R1 obtains one or more metrics from the agent 302, representative of the quality of the connection between the station 301 and the access point managed by the agent 302. In 1.2, controller 303 evaluates the metrics and decides whether or not the station 302 is eligible for a move. For the purposes of FIG. 3, it will be assumed that it is. The controller 303 then transmits a message in 1.3 to the device 306 informing it that a station is eligible. In a non-limiting embodiment, the message comprises an identifier for the eligible station, such as its MAC address.

In 2.1, the controller 303 of the network R1 requests a list of visible adjacent networks from the agent 302 of that same network. In 2.2, the agent listens to adjacent networks and obtains their identifiers from the beacon frames. In 2.3, a list of the identifiers of visible adjacent networks is transmitted to controller 303, which in 2.4 forwards it to the service provider device 306.

In 3.1, the device 306 asks the controllers of the visible adjacent networks (here the controllers 305 and 307 of the networks R2 and R3) to provide metrics for the eligible station 301 seen from each access point of each of these networks (in the case of the simple example in FIG. 3, respectively the access point managed by the agent 304 for the network R2 and the access point managed by the agent 308 for the network R3). Controllers initiate the phase of obtaining metrics from agents in 3.2 and agents implement it in 3.3, for example in the case of an ‘EasyMesh’ network via the monitoring function mentioned above. The metrics are sent back by each agent 304 and 308 to its respective controller in 3.4. The controllers 305 and 307 process these metrics to obtain data that can be used—for example, a score based on the metrics—by the device 306 to select a host access point from those proposed. This choice is made in 3.6.

In the example shown in FIG. 3, the access point of the network R3 is selected as the host access point. In 4.1, the controller 303 of the network R1 transmits the connection elements of the network R2 to the device 306, for example following a request (not shown) made by the device 306 to the controller 303 of the network R1.

In 4.2, the device 306 transmits connection elements from the network R2 to the controller 307 on the network R3. These elements were previously obtained by the device 306. In 4.3, the controller 307 of the network R3 initiates wireless network configuration with the agent 308 at the host access point. Connection details are transmitted to the agent 308 for this purpose.

It should be noted that the example of the transmission of connection elements from the first network to the host access point may take other paths and/or take place at other times. In particular, the transmission can be made directly to the host access point without going through the device 306. In this case, the controller of the first network is informed of the identifier of the host access point before it is configured. For example, connection elements can be transmitted in phase 1, in parallel with transmission 1.3 of the identifier of the eligible station. The person skilled in the art will know how to adapt the chronology of steps to the context and needs.

In 5.1, the device 306 transmits a host access point identifier to the controller 303 of the eligible station's network R1. In 5.2, this data enables the controller to send the agent managing the access point to which the eligible station 301 is connected, a request to transition from the station 301 to the host access point. This request is relayed by the agent 302 to the station 301 as described in 5.3. The station 301 then transitions to the host access point in a manner known per se (not shown).

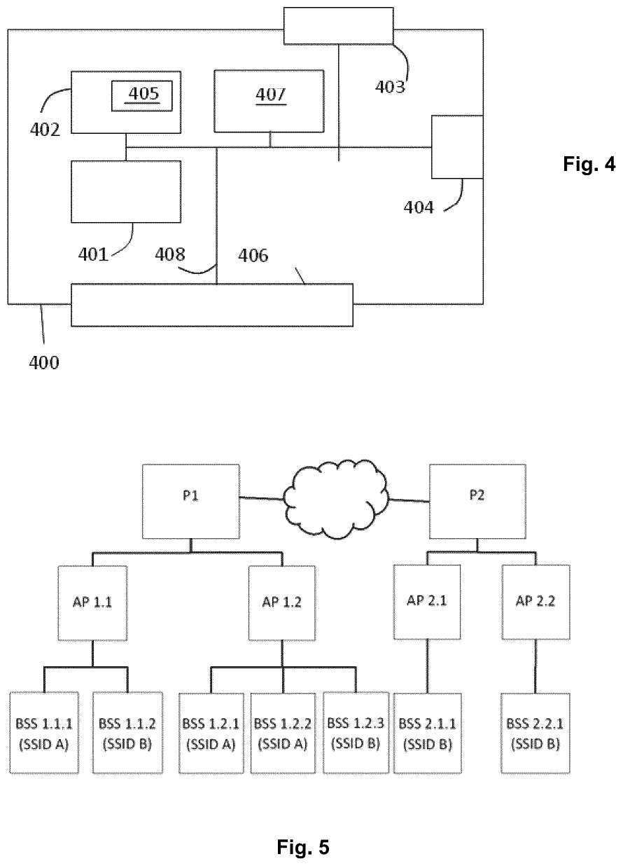

FIG. 4 is a block diagram of a device 400 that can be used to implement one of the methods described. The device 400 comprises a processor 401, a memory 402, a user interface 403, a communication interface 404 enabling communication with other devices of the wireless network, a display 406 suitable for displaying data to a user, as well as a working memory 407.

The various components of the device 400 are connected via a communication bus 404. The memory 402 comprises software code 405. The memory 407 is used to store and manage the data to be transmitted. The device may comprise other components, and some components may be absent, as required by the use case and the function of the device. When the processor executes software code 405, it causes the device to implement a method according to one or more of the described embodiments, such as those described in connection with FIG. 2 and/or FIG. 3. The device 400 can be a gateway, a terminal or mobile station, an access point or another network device, such as equipment belonging to or connected to the telecommunications network operator.

Example 1—Method carried out by a first communication device comprising:
receiving an identifier from a station connected to a first access point of a first set of access points broadcasting a first wireless network, the first wireless network being configured with first connection elements, the connection elements comprising information necessary and sufficient for a station to connect to a wireless network;
determining at least one second set of access points broadcasting a second wireless network, each second set of access points comprising at least one second access point within range of the station so that the station can connect thereto, each second wireless network being configured with respective second connection elements, distinct from the first connection elements;
determining, from the at least one second access point, a given access point for connecting the station;
initiating the transmission, to the given access point, of a request to configure a third wireless network by the given access point, said configuration using the connection elements of the first wireless network;
transmitting to the first wireless network a message comprising an identifier of the given access point to initiate a move of the station to the given access point.

Example 2—A method implemented by a second communication device of a first wireless communication network broadcast by a first set of access points, the method comprising:
transmitting, to a first communication device, an identifier of a station connected to an access point of the first communication network,
transmitting first connection elements for configuring an access point of a second communication network within range of the station, the second wireless network being broadcast by a second set of access points and being configured with second connection elements distinct from the first connection elements, the connection elements comprising information necessary and sufficient for a station to connect to a wireless network configured with these elements;
receiving, from the first communication device, an identifier of a given access point of the second set of access points having configured a third wireless communication network with the first connection elements;
initiating a move of the station to the given access point.

1. A method carried out by a first communication device, comprising:
receiving an identifier from a station connected to a first access point of a first set of access points broadcasting a first wireless network, the first wireless network being configured with first connection elements, the connection elements comprising information necessary and sufficient for a station to connect to a wireless network;
determining at least one second set of access points broadcasting a second wireless network, each second set of access points comprising at least one second access point within range of the station so that the station can connect thereto, each second wireless network being configured with respective second connection elements, distinct from the first connection elements;
determining, from the at least one second access point, a given access point for connecting the station;
initiating the transmission, to the given access point, of a request to configure a third wireless network by the given access point, said configuration using the connection elements of the first wireless network;
transmitting to the first wireless network a message comprising an identifier of the given access point to initiate a move of the station to the given access point, to enable the station to connect to the third network using the connection elements of the first wireless network.

2. The method according to claim 1, comprising
receiving the first connection elements from the first wireless network; and
initiating the transmission of the first connection elements to the given access point.

3. The method according to claim 1, the first connection elements comprising an SSID of the first wireless network, a password, and an encryption mode.

4. The method according to claim 1, the determination of at least a second set of access points broadcasting a second wireless network and of the given access point comprising:
obtaining one or more respective identifiers of one or more second wireless networks from the first wireless network;
transmitting, to each of the one or more second networks identified by the respective identifier(s), a request to obtain at least one quality criterion of at least one access point of each of the one or more second identified networks, the quality criterion being a function of a signal measurement between the at least one access point and the station;
receiving at least one quality criterion for at least one access point;
selecting the given access point on the basis of at least one quality criterion.

5. The method according to claim 4, wherein the quality criterion is additionally a function of at least one of:
a number of stations connected to an access point of a second identified network; and
an available transmission time of an access point of a second identified network.

6. The method according to claim 1, the determination of a second given access point comprising:
determining at least one second network on the basis of a criterion of geographical proximity of the at least one second network to the first network.

7. The method according to claim 1, wherein the at least one second wireless network is a mesh network.

8. The method according to claim 1, a set of access points comprising one or more access points.

9. A method implemented by a second communication device of a first wireless communication network broadcast by a first set of access points, the method comprising:
transmitting, to a first communication device, an identifier of a station connected to an access point of the first communication network,
transmitting first connection elements for configuring an access point of a second communication network within range of the station, the second wireless network being broadcast by a second set of access points and being configured with second connection elements distinct from the first connection elements, the connection elements comprising information necessary and sufficient for a station to connect to a wireless network configured with these elements;
receiving, from the first communication device, an identifier of a given access point of the second set of access points having configured a third wireless communication network with the first connection elements;
initiating a move of the station to the given access point to enable the station to connect to the third network using the connection elements of the first wireless network.

10. The method according to claim 9, comprising checking whether a connection quality criterion of a station connected to an access point of the first wireless network is below a threshold, a station identifier being transmitted if so.

11. The method according to claim 9, comprising:
transmitting to at least one access point of the first set of access points a request to determine one or more second networks within range of the at least one access point;
receiving, from the at least one access point, one or more respective identifiers of the second networks determined to be within range;
transmitting the identifier(s) of the second network(s) within range to the first device.

12. The method according to claim 9, a set of access points comprising one or more access points.

13. A first communication device comprising a processor configured to implement the method according to claim 1.

14. A second communication device comprising a processor configured to implement the method according to claim 9.

15. The second device according to claim 14, the device comprising a mesh network controller.
